(19) United States
(12) Patent Application Publication
(10) Pub. No.: US 2006/0245405 A1
(43) Pub. Date: Nov. 2, 2006

(54) Portable communication device with internet phone module

(76) Inventors: Chi Wen Liu, Hsin Chu City (TW); Ching Yu Chang, Yi Lan Xian (TW); Kuo Ching Chiang, Taoyuan Hsien (TW)

Correspondence Address: THE MAXHAM FIRM, 750 "B" STREET, SUITE 3100, SAN DIEGO, CA, 92101, US

(21) Appl. No.: 11/120,005

(22) Filed: May 2, 2005

(51) Int. Cl. H04Q 7/24

(52) U.S. Cl. 370/338

(57) ABSTRACT

A portable device with dual network linking capability module to transmit information through a wire area network or the local area network, wherein the portable device includes an internet phone module to allow a user may synchronously transmit or receive data through the local area network, portably, wherein the data is audio, video or the combination thereof.

### FIELD OF INVENTION

The present invention relates to a portable device, particularly to a portable device that is capable of providing communication service via WLAN.

### BACKGROUND OF INVENTION

Because of the development of the information technology (IT), the information could be exchanged with higher capacity and faster speed. Internet is designed as an open structure to exchange information freely without restriction. Thus, certain communication service requiring real time information exchange, such as viewing a live video, has become feasible through Internet. The VoIP (Voice over Internet Protocol) is a popular Internet protocol about the transmission of voice data packets. Conventionally, the VoIP operators are needed to obtain telephone lines from phone companies for linking themselves to the regular phone systems. Therefore, the applications of VoIP are still constrained within the Internet users.

### SUMMARY OF THE INVENTION

The present invention provides a system for synchronously communication via internet comprising a local area network and a terminal is coupled to the internet; a portable device with dual network linking capability module is used to transmit information through a RF module or the wireless local area network (WLAN) module, wherein the portable device includes an internet phone module and the WLAN module to allow a user may synchronously transmit or receive data through the internet, portably, wherein the transmitted information is selected from audio signal, video signal and the combination thereof. The terminal can be a computer, a personal digital assistant (PDA), a notebook, cellular or a smart phone, which is able to access the internet network via the local area network. The system further comprises a mobile phone communication service network. The system further comprises an exchanging service mechanism bridging the internet and the mobile phone network to facilitate the communication there between. The system may further comprise a public switch telephone network (PSTN).

The present invention provides a portable device for synchronously communication via internet comprising: a central control unit, an operation panel, a display, an operation system and memory coupled to the central control unit, respectively; a RF module that is compatible to a mobile phone communication protocol; a wireless local area network (WLAN) module that is compatible to a local area network protocol; CODEC and A/D converter are coupled to the WLAN module and the RF module; a vocal I/O unit is coupled to the A/D converter; and an Internet phone module is introduced, the Internet phone module accompany with the WLAN module allow a user may synchronously transmit or receive data through Internet by the wireless local area network module, portably, wherein the data is selected from the group consisting of audio signal, video signal and the combination thereof. The WLAN module includes Bluetooth standard compatible module, Wi-Fi standard compatible module or 802.11x standard compatible module, wherein the x can be a, b, or g. The wireless local area network (WLAN) module could be compatible to the WiMAX (Worldwide Interoperability for Microwave Access) standard.

The present invention provides a portable device with dual network linking capability module to transmit or receive information through a mobile phone communication service network or the Internet, wherein the portable device includes an Internet phone module and the WLAN module to allow a user may synchronously transmit or receive data through the local area network, portably, wherein the data is selected from audio, video and the combination thereof.

The present invention discloses a method for a portable device to communicate through an Internet, comprising: providing the portable device with an Internet phone module and a wireless local area network (WLAN) module; coupling to the Internet via the wireless local area network (WLAN) module by using the Internet phone module; transmitting or receiving data through the Internet via the WLAN module, portably, wherein the data is audio signal, video signal, digital data and the combination thereof.

The portable device further comprises a RF module and a wired data I/O interface. The wireless local area network (WLAN) module includes Bluetooth standard compatible module, Wi-Fi standard compatible module, includes 802.11x standard compatible module or WiMAX (Worldwide Interoperability for Microwave Access) standard compatible module.

### BRIEF DESCRIPTION OF THE DRAWING

For a better understanding of the present invention and to show how it may be implemented, reference will now be made to the following drawings:

FIG. 1 is a block diagram showing the communication service system of the present invention.

FIG. 2 is a block diagram showing one embodiment of the device of the present invention.

### DESCRIPTION OF THE PREFERRED EMBODIMENT

The present invention is described with the preferred embodiments and accompanying drawings. It should be appreciated that all the embodiments are merely used for illustration. Hence, the present invention can also be applied to various embodiments other than the preferred embodiments.

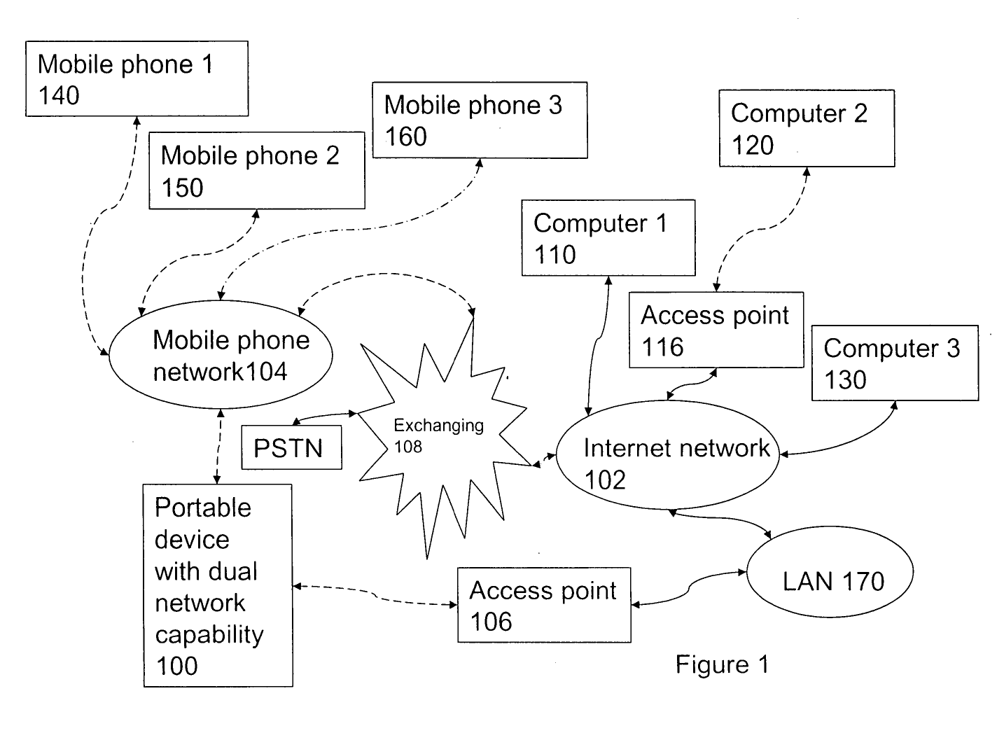

In FIG. 1, the system includes at least two different communication networks including a mobile phone network 104 such as a GSM, CDMA or PHS communication service network and a local area network (LAN) 170 is coupled to an Internet 102. It should be noted that the LAN 170 is optional. There are pluralities of terminals of the users in FIG. 1. For example, the terminals (mobile phone) 140, 150 and 160 of the users are coupled to the mobile phone communication service network 104. Similarly, computers 110, 120, and 130 are coupled to the Internet 102, respectively. In one case, computers 110 and 130 are wired to the Internet 102 while the computer 120 is wirelessly coupled to the Internet 102 through the access point 116. It should be noted that the number of the terminals can be changed, and the present invention would encompass any possible number of the terminals. As we can see, computers are all coupled to Internet network 102, and the computer could be replaced by the terminals including but not limited to the PDA, notebook, cellular or the smart phone, which are able to access the Internet 102. The data exchange between them could be implemented directly through Internet 102.

The terminals 140, 150 and 160 and terminals 110, 120 and 130, for instance, are situated in different networks, which are Internet 102 and mobile phone network 104. The two types of terminals therefore could not communicate with each other directly. According to the preferred embodiment of the present invention, an exchanging service mechanism 108 bridging the two different networks is provided to facilitate the communication between terminals in the two networks. Namely, the exchanging service mechanism 108 is able to relay and link services between systems or networks.

An access point 106 or 116 is coupled to the internet network to provide the entry to the local area network for wireless communication. One aspect of the present invention is that the system includes a portable device with dual network capability 100. It means that the device 100 may transmit and receive information through the mobile phone network or the Internet. The transmitted or the received information includes audio signal, video signal or both.

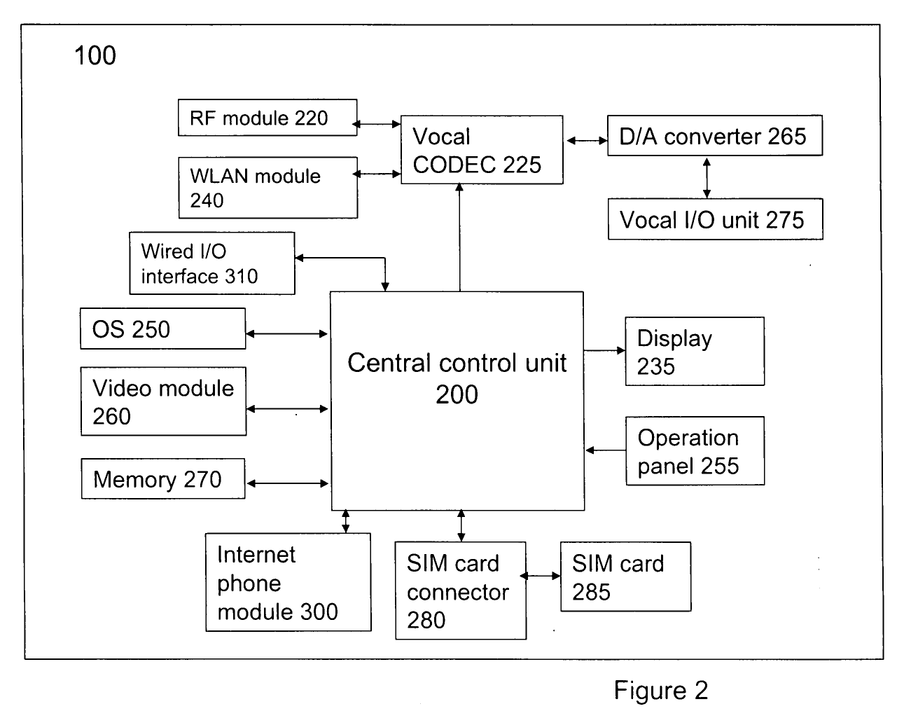

Referring to FIG. 2, it illustrates the functional diagram of the portable device 10 with dual networks capability. The dual way portable terminal 10 with SIM card connector 280 to carry the SIM card 285, it is well know in the art, the SIM card is not necessary for some other type of cellular such as PHS system. The diagram is used for illustrating and not used for limiting the scope of the present invention. The portable terminal or device 10 includes a RF module 220 to transmit or receive mobile phone signal and it is well know in the art. As know in the art, it may include a RF unit, an antenna, DSP, base band processor and so on. This antenna is connected to a transceiver, which is used to receive and transmit signal. The RF module 220 is compatible to the mobile phone protocol such as GSM, CDMA, PHS system. The RF module 220 may perform the function of signal transmitting and receiving, frequency synthesizing, base-band processing and digital signal processing. The SIM card hardware interface is used for receiving a SIM card. Finally, the signal is send to the final actuators, i.e. a vocal I/O unit 275 including loudspeaker and a microphone.

The device 10 includes CODEC 225 and A/D converter 265 as well. Both of the modules 220, 240 are coupled to the CODEC 225. Due to the RF module 220 is not the feature of the present invention, therefore, the detailed description is omitted. The present invention includes a central control unit 200, an operation panel 225, a build-in display 235, OS (operation system) 250 and memory 270 including a ROM program memory, a RAM memory and a nonvolatile FLASH memory. All of the units mentioned above are coupled to the central control unit 200, respectively. The memory could be micro-type hard disc. A wired I/O interface 310 is coupled to the central control unit 200. The wired I/O interface 310 could be USB, IEEE1394.

One aspect of the present invention is that the device 10 further includes a wireless local area network (WLAN) module 240. It could be compatible to the local area network protocol or standard such as Bluetooth standard, Wi-Fi standard or 802.11x standard compatible module. Further, the wireless local area network (WLAN) module could be compatible to the WiMAX (Worldwide Interoperability for Microwave Access) standard. An Internet phone module 300 are coupled to the central control unit 200 to allow transmit and receive the audio, video or both type signal to/from the internet network through the local area wireless transmission module 240. Internet phone module 300 at least meets the standard of Voice Over Internet Protocol (VoIP). By virtual of the Internet phone module 300 and the wireless local area network module 240, the user may portably, synchronously transmit and receive the vocal, video or both signal through the internet by using the internet phone module 300. An image capturing module 260 is required and coupled to the central control unit 200 to catch the video image if the user would like to conduct the real-time video transmission. The image capturing module could be digital still camera, digital video camera. Therefore, the real-time portable conference is possible. In another embodiment, the one difference is that the device may omit the RF module 220.

The system of FIG. 1 may couple to PSTN for linking to the home telephone system. The service relay may connect to the telephone with the link information through Internet. It should be appreciated that the device types of terminals could be varied depending on the support of available networks. The present invention would encompass possible communication devices with the ability to access the various networks.

The device may couple to the internet via the wired data I/O interface 310 or the WLAN module 240 to upload or download data including digital data such as text format, image format, audio signal, video signal. The wired data I/O interface 310 is coupled to the central control unit 200. The application of the apparatus is quite economical and convenience. Moreover, the user may call other one by the internet phone module 300 to reduce the transmission fee when the local area wireless transmission module 240 detects the signal of the internet network. Otherwise, the user may use the GSM CDMA or PHS system. The portable real-time video conference is possible by implementation of the present invention. Further, the present invention provides dual way (transmission and receiving) portable audio/video communication, synchronously.

As is understood by a person skilled in the art, the foregoing preferred embodiments of the present invention are illustrated of the present invention rather than limiting of the present invention. It is intended to cover various modifications and similar arrangements included within the spirit and scope of the appended claims, the scope of which should be accorded the broadest interpretation so as to encompass all such modifications and similar structure. While the preferred embodiment of the invention has been illustrated and described, it will be appreciated that various changes can be made therein without departing from the spirit and scope of the invention.

What is claimed:

1. A system for synchronously communication via Internet comprising:
a local area network (LAN);
a terminal coupled to said internet;
a portable device with network linking capability module to communicate with said terminal through a mobile phone communication service network or said Internet via said local area network, wherein said portable device includes an Internet phone module and wireless local area network (WLAN) module to allow a user may synchronously transmit or receive data through said Internet, portably.

2. The system as set forth in claim 1, wherein said terminal is a computer, a personal digital assistant (PDA), a notebook, cellular or a smart phone, which is able to access said internet.

3. The system as set forth in claim 1, further comprising an access point coupled between said LAN and said portable device.

4. The system as set forth in claim 3, wherein said system further comprising an exchanging service mechanism for bridging said internet network and said mobile phone communication service network to facilitate the communication there between.

5. The system as set forth in claim 1, wherein said data includes audio signal, video signal, digital data and the combination thereof.

6. The portable device as set forth in claim 1, wherein said wireless local area network (WLAN) module includes Bluetooth standard compatible module.

7. The portable device as set forth in claim 1, wherein said wireless local area network (WLAN) module includes Wi-Fi standard compatible module.

8. The portable device as set forth in claim 1, wherein said wireless local area network (WLAN) module includes 802.11x standard compatible module.

9. The portable device as set forth in claim 1, wherein said wireless local area network (WLAN) module includes WiMAX (Worldwide Interoperability for Microwave Access) standard compatible module.

10. A portable device for communication via Internet comprising:
a central control unit,
an operation panel, a display, an operation system and memory coupled to said central control unit, respectively;
CODEC and A/D converter coupled to said central control unit;
a wireless local area network (WLAN) module;
a vocal I/O unit coupled to said A/D converter; and
an Internet phone module coupled to said central control unit to allow a user may synchronously transmit or receive data through said Internet by said wireless local area network (WLAN) module, portably, wherein said data is audio signal, video signal, digital data and the combination thereof.

11. The portable device as set forth in claim 10, wherein said wireless local area network (WLAN) module includes Bluetooth standard compatible module.

12. The portable device as set forth in claim 10, wherein said wireless local area network (WLAN) module includes Wi-Fi standard compatible module.

13. The portable device as set forth in claim 10, wherein said wireless local area network (WLAN) module includes 802.11x standard compatible module.

14. The portable device as set forth in claim 10, wherein said wireless local area network (WLAN) module includes WiMAX (Worldwide Interoperability for Microwave Access) standard compatible module.

15. The portable device as set forth in claim 10, wherein said portable device further comprises a RF module.

16. The portable device as set forth in claim 10, wherein said portable device further comprises a wired data I/O interface.

17. A method for a portable device to communicate through an Internet, comprising:
providing said portable device with an Internet phone module and a wireless local area network (WLAN) module;
coupling to said Internet via said wireless local area network (WLAN) module;
transmitting or receiving data through said Internet via said WLAN module by said Internet phone module, wherein said data is audio signal, video signal, digital data and the combination thereof.

18. The method as set forth in claim 17, wherein said wireless local area network (WLAN) module includes Bluetooth standard compatible module, Wi-Fi standard compatible module, includes 802.11x standard compatible module or WiMAX (Worldwide Interoperability for Microwave Access) standard compatible module.

19. The method as set forth in claim 17, wherein said portable device further comprises a RF module.

20. The method as set forth in claim 17, wherein said portable device further comprises a wired data I/O interface.
